(19) United States
(12) Patent Application Publication
(10) Pub. No.: US 2024/0315276 A1
(43) Pub. Date: Sep. 26, 2024

(54) A METHOD FOR MANUFACTURING A FOOD PRODUCT FROM YEAST AND A YEAST BASED FOOD PRODUCT

(71) Applicant: USARIUM INC., San Francisco, CA (US)

(72) Inventor: Aleh MANCHULIANTSAU, San Francisco, CA (US)

(21) Appl. No.: 18/578,891

(22) PCT Filed: Jul. 13, 2022
(86) PCT No.: PCT/US2022/073663

§ 371 Date: Jan. 12, 2024

Related U.S. Application Data
(60) Provisional application No. 63/221,755, filed on Jul. 14, 2021.

(51) Int. Cl. A23J 1/18; A23J 3/16; A23J 3/20; A23J 3/22; A23J 3/26

(52) U.S. Cl. CPC A23J 1/18; A23J 3/16; A23J 3/20; A23J 3/227; A23J 3/26

(57) ABSTRACT

A method for manufacturing a food product from yeast and a yeast based food product is provided. The method comprises thermo-mechanically processing a mixture comprising a liquid yeast and a secondary protein ingredient utilizing a temperature of at least 90 degrees Celsius and at an elevated pressure of at least 8 bar to form the food product. The mixture comprises a range of 40% to 80% of the liquid yeast based on the total weight of the mixture and a ribonucleic acid content in the food product is less than 4% of the dry protein weight of the food product.

### CROSS-REFERENCE

This application claims priority to U.S. patent application Ser. No. 17/571,995, which was filed on Jan. 10, 2022, U.S. patent application Ser. No. 17/572,036, which was filed on Jan. 10, 2022, U.S. patent application Ser. No. 17/474,075, which was filed on Sep. 14, 2021, U.S. patent application Ser. No. 17/475,664, which was filed on Sep. 15, 2021, and U.S. Provisional Patent Application No. 63/221,755 filed on Jul. 14, 2021. The entire contents of each are hereby incorporated by reference.

### BACKGROUND

Spent brewer's yeast (SBY) is a by-product of the brewing industry. The spent yeast cells are removed at the end of the bulk fermentation. A small amount of the spent yeast cells can be used to start the next batch of fermentation, the remaining part of the spent yeast cells are typically discarded. The spent yeast cells can be high in nutrients, such as, proteins, vitamins, and minerals, as well as containing functional and biologically active compounds such as polyphenols, antioxidants, ß-glucans and mannoproteins.

Production of meat substitutes from SBY and soy protein is described by D. L. Gibson and B. K. Dwivedi in Can Inst. Food Technol. J Vol 3, No. 3, 1970. There have been concerns of having high levels of yeast feeding on uric acid metabolism of young men, expressed by J. C. Edozien et al in Nature vol 228, 1970. Based on this concern, they set a safe limits of Ribonucleic acid (RNA) for a human diet at 2 g per day. SBY typically contains about 10-15% by dry weight of RNA. Because of the high RNA content, SBY-based protein consumption may be limited to 13-20 g per day, which can make it difficult to utilize SBY containing meat substitutes given the FDA recommended allowances for protein of 50 g based on a 2,000 calorie daily diet and 60 g per day average protein consumption from red meat, poultry, and fish (boneless weight) in the US. Therefore, the use of SBY in food applications is limited to no more than 20% by weight.

Known chemical, enzymatic, and heat treatment methods of reducing RNA content in SBY still limit the consumption of SBY-based protein and the use of SBY for human applications is limited to debittered, dried, or autolyzed flavor-enhancing extracts with up to 2% by weight inclusion in the food products. Currently, the majority of the liquid SBY is composted or used as animal feed. There are challenges with processing SBY into human consumable foods.

### SUMMARY

In one general aspect, a method of processing liquid yeast into a food product is provided. The method comprises thermo-mechanically processing a mixture comprising a liquid yeast and a secondary protein ingredient utilizing a temperature of at least 90 degrees Celsius and at an elevated pressure of at least 8 bar to form the food product. The mixture comprises a range of 40% to 80% of the liquid yeast based on the total weight of the mixture and a ribonucleic acid content in the food product is less than 4% of the dry protein weight of the food product.

In another general aspect, a food product is provided. The food product comprises at least 20% of a yeast by weight based on the dry weight of the food product and a ribonucleic acid (RNA) content less than 4% by weight based on the dry weight of the food product.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this disclosure.

### BRIEF DESCRIPTION OF THE DRAWINGS

The features and advantages of the examples, and the manner of attaining them, will become more apparent, and the examples will be better understood, by reference to the following description of embodiments taken in conjunction with the accompanying drawings, wherein:

FIGS. 1A-1C are a meat-like product with a muscle-like texture made according to Example 1 of the present disclosure;

FIG. 2 is a textured product similar to vegetable bacon bits made according to Example 2 of the present disclosure

FIG. 3 is a chicken skewer made according to Example 3 of the present disclosure.

FIG. 4 is a hop-char burger made according to Example 4 of the present disclosure.

FIG. 5 is a beef stew made according to Example 5 of the present disclosure;

FIG. 6 is a pulled pork lemongrass veggie bowl made according to Example 6 of the present disclosure.

The exemplifications set out herein illustrate certain embodiments, in one form, and such exemplifications are not to be construed as limiting the scope of the appended claims in any manner.

### DETAILED DESCRIPTION

Various examples are described and illustrated herein to provide an overall understanding of the structure, function, and use of the disclosed methods, systems, compositions, and products. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various examples disclosed and described in this specification can comprise, consist of, or consist essentially of the features and characteristics as variously described herein.

Yeast, such as, for example, spent brewer's yeast (SBY) can have an undesirable high RNA content and therefore can be unsuitable for food products. Currently, SBY is typically composted and/or used as animal feed. In light of these challenges, the present disclosure provides a method for manufacturing food product from yeast and yeast based food product, which can have a reduced RNA content and can be suitable for human consumption.

A method of processing liquid yeast into an food product is provided. The method comprises thermo-mechanically processing a mixture comprising a liquid yeast and a secondary protein ingredient to form the food product.

The liquid yeast can comprise SBY, spent distillers' yeast, bakers' yeast, nutritional yeast, surplus yeast from ethanol manufacturing, or a combination thereof. For example, the liquid yeast comprise SBY. In various examples, the liquid yeast is derived from various strains of Saccharomycetes class, such as, for example, Saccharomyces cerevisiae, Saccharomyces pastorianus, and Saccharomyces carlsbergensis. The liquid yeast can have a ribonucleic acid (RNA) content of no less than 5% by dry weight of the liquid yeast, such as, for example, no less than 10% of the dry of the liquid yeast, no less than 11% of the dry of the liquid yeast, no less than 12% by dry weight, no less than 15% by dry weight, or no greater than 20% by dry weight, all based on the dry weight of the liquid yeast.

The liquid yeast may contain a solids content in a range of 8% to 60% solids, such as, for example, 8% to 11%, 8% to 25%, 10% to 40%, 15% to 25%, 20% to 60%, 20% to 50%, 30% to 60%, or 40% to 60%. The moisture content and corresponding solids content of the mixture can be measured by an AND ML-50 moisture analyzer.

The source of the yeast to form the liquid yeast can be a dry form, a concentrated form, a liquid form, or a combination thereof. For example, the liquid yeast can be obtained by mixing dry yeast with a liquid (e.g., water, oil, milk (animal, plant), whey), such as, for example, mixing dry SBY and a liquid, resulting in mixture comprising a range of 8% to 60% by weight of solids based on the total weight of the mixture. In various examples, the liquid yeast can be debittered, autolyzed, hydrolyzed, or a combination thereof. SBY has been used for human consumption in the dried form. The use of liquid SBY (e.g., containing a range of 8% to 11% by weight solids) and liquid concentrated SBY (e.g., containing a range of 15% to 25% by weight solids) may benefit the manufacturing of high moisture meat analogs and simultaneously reduce costs associated with drying.

The secondary protein ingredient can comprise a vegetable protein, a microbial protein, a fungal protein, an animal protein, a cultured protein, or a combination thereof. The secondary protein can be in a native form, a concentrated form, an isolated form, or a combination thereof. In various examples, the secondary protein ingredient may also comprise a fat, a carbohydrate, a flavoring, a color additive, or a combination thereof. For example, the second protein ingredient may comprise a range of 1 to 15% Fat, 0.5 to 2% dry weight Calcium Chloride, 0.5 to 1.5% dry weight gums (e.g., Sodium Alginate), and 0.2-0.6% dry weight Lecithin.

The mixture can comprise a range of 40% to 80% of the liquid yeast based on the total weight of the mixture, such as, for example, 60% to 80% by weight, 65% to 70% by weight, 40% to 70% by weight, or 40% to 60% by weight, all based upon the total weight of the mixture.

The mixture can comprise a range of 20% to 60% by weight of the secondary protein ingredient based upon the total weight of the mixture, such as, for example, 20% to 50% by weight, 20% to 40% by weight, or 40% to 60% by weight, all based on the total weight of the mixture. For example, the product can comprise 80% of the liquid yeast and 20% secondary protein ingredient, 70% of the liquid yeast and 30% secondary protein ingredient, 60% of the liquid yeast and 40% secondary protein ingredient, 50% of the liquid yeast and 50% secondary protein ingredient, 40% of the liquid yeast and 60% secondary protein ingredient, or other range of ingredients.

Varying the ratio of liquid yeast to the secondary protein ingredient can vary the texture of the resulting product. For example, increasing the ratio of liquid yeast to the secondary protein ingredient can increase the moisture in the resulting product similar to animal meat (e.g., the resulting product can be a high moisture meat analog (HMMA)). A liquid yeast content in a range of 20% to 40% by total weight of the mixture and a secondary protein content in a range of 60% to 80% by total weight of the mixture can result in a drier food product, similar to textured vegetable protein.

The thermo-mechanically processing can utilizing an elevated temperature and an elevated pressure. The combination of the elevated temperature, elevated pressure, and mechanical action has been surprisingly discovered to reduce the RNA content in the mixture resulting from the liquid yeast while maintaining a desirable nutritional content, texture, and processing time. The elevated temperature can be constant or varying. The elevated temperature can be at least 90 degrees Celsius, such as, for example, at least 100 degrees Celsius, at least 110 degrees Celsius, at least 120 degrees Celsius, at least 140 degrees Celsius. The elevated temperature can be no greater than 180 degrees Celsius, such as, for example, no greater than 170 degrees Celsius, no greater than 160 degrees Celsius, or no greater than 150 degrees Celsius. In various examples, the elevated temperature can be in a range of 90 degrees Celsius to 180 degrees Celsius, such as, for example, 100 degrees Celsius to 180 degrees Celsius, 120 degrees Celsius to 180 degrees Celsius, 140 degrees Celsius to 170 degrees Celsius, or 140 degrees Celsius to 160 degrees Celsius. The elevated pressure can be constant or varying. The elevated pressure can be at least 8 bar, such as, for example, at least 9 bar, at least 10 bar, at least 15 bar, at least 20 bar, at least 30 bar, or at least 50 bar. The elevated pressure can be no greater than 150 bar, no greater than 140 bar, no greater than 120 bar, no greater than 100 bar, or no greater than 80 bar. In various example, the elevated pressure can be in a range of 8 bar to 150 bar, such as, for example, 10 bar to 150 bar, 15 bar to 150 bar, 10 bar to 80 bar, 20 bar to 150 bar, or 20 bar to 60 bar. For example, the thermo-mechanically processing can be performed at 150 degrees Celsius, a pressure of 20 bar, and a time period of 2 minutes for a mixture comprising a range of 60% to 80% by weight liquid SBY and a range of 20% to 40% by weight of a secondary protein ingredient. In examples comprising extrusion, the elevated pressure and elevated temperature can be measured in the barrel of the extruder. In certain examples comprising extrusion, the rotation of the extruder may be in a range of 250 RPM to 1800 RPM.

The thermo-mechanical processing of the mixture can be continuous or batch processing and can occur for a time period of at least 1 minute, such as, for example, at least 2 minutes, at least 3 minutes, or at least 4 minutes. The time period can be no greater than 5 minutes. In various example, the time period can be in a range of 1 minute to 5 minutes.

The thermo-mechanically processing, can comprise various processes, such as, for example, an extrusion process, a shear cell process, or a combination thereof. The extrusion process can comprise a high moisture extrusion process. The extrusion process can comprise an extrusion process as described in Int'l Patent Application No. PCT/US2020/052385, filed Sep. 24, 2020, which is hereby incorporated by reference. The extrusion can occur in a single screw extruder, a twin screw extruder, or an extruder with three or more screws. The shear cell process can comprise a shear cell process as described in Steven H. V. Cornet, et al. (2021): “Thermo-mechanical processing of plant proteins using shear cell and high-moisture extrusion cooking”, Critical Reviews in Food Science and Nutrition, which is hereby incorporated by reference

The thermo-mechanical processing of the mixture can produce an food product (e.g., a textured vegetable protein, an alternative meat, an application thereof, a combination thereof). The food product can have a ribonucleic acid (RNA) content in the food product is less than 4% by weight of the dry protein weight of the food product, such as, for example, no greater than 3% of the dry protein weight, no greater than 2% by weight, no greater than 1% by weight, no greater than 0.5% by weight, or no greater than 0.14% by weight, all based on the dry protein weight of the food product. In various examples, the RNA content in food product is less than 2 g per serving.

In various examples, the food product can comprise 5 percent to 70 percent of protein based on the dry weight of the food product, such as, for example, 10 percent to 70 percent of protein, 20 percent to 70 percent of protein, 30 percent to 70 percent protein, 40 percent to 70 percent protein, or 50 percent to 70 percent protein based on the dry weight of the food product.

In various examples, the food product can comprise 5 percent to 70 percent of moisture based on the total weight of the food product, such as, for example, 10 percent to 70 percent moisture, 15 percent to 50 percent moisture, 20 percent to 60 percent moisture, 60 percent to 70 percent, or 25 percent to 45 percent moisture based on the total weight of the food product. The moisture content of the product can be measured by an AND ML-50 moisture analyzer. In various examples, the food product can comprise 1 percent to 20 percent of fat based on the total weight of the food product, such as, for example, 1 percent to 15 percent fat, 2 percent to 15 percent fat, 2 percent to 5 percent, 5 percent to 15 percent fat, or 5 percent to 20 percent fat based on the total weight of the food product.

The food product can comprise a range of 3% to 20% by dry weight of protein from a yeast source based on the total dry weight of the food product, such as, for example, 3% to 17.5%, 3% to 15%, 5% to 20%, 10% to 20%, or 7% to 16%, all by dry weight of protein from a yeast source based on the total dry weight of the food product.

The food product can comprise at least 20% of a yeast by weight based on the dry weight of the food product.

In various examples, the food product can comprise 30% dry weight SBY yeast, 10% dry weight Soy protein isolate, an animal meat-like appearance and palatability, 24.4% by weight total protein content (e.g., similar to animal meat) and 0.099% RNA by total dry weight of the food product which is unexpected.

The food product according to the present disclosure can be consumed at more than 10 times the FDA recommended daily amount of protein in 2022, which is equivalent to more than 2 kg of animal meat (e.g., 8.96 times higher than average daily meat consumption from red meat, poultry, and fish (boneless weight) in the US according to USDA).

The use of yeast in a liquid form can reduce manufacturing costs typically associated with debittering, drying, extraction, and/or by-product utilization. Naturally occurring yeast and the secondary protein ingredient can have a meaty flavor and BBQ-like color, which can reduce the need for maskers, bitter blockers, flavors, and coloring.

Co-thermo-mechanical processing of SBY with a secondary protein ingredient can provide a desirable aftertaste, improve succulent mouthfeel because of native fiber, add meaty flavor and BBQ-like color, and reduce costs for debittering and drying. The resulting low RNA concentration allows an increased inclusion of SBY in the mixture to tweak the appearance and the taste towards chicken, fish, beef, and pork-like applications, capable of retaining moisture without adding gums, reducing costs for secondary ingredients such as maskers, bitter blockers, flavors, gums, and colors resulting in costs cheaper than animal meat.

A comparison of the present disclosure to prior methods and products is shown in Table 1 below:

TABLE 1
Methods for RNA reduction

| | | | | | Present | |
|---|---|---|---|---|---|---|
| | | | | | disclosure | |
| | | | | | with an | |
| | | | | | example | |
| | | | | | mixture | |
| | | | | | comprising | |
| | | | Phosphate | Alkaline | 70 wt. % liquid | |
| | | | solution, heat | Hydrolysis and | SBY and | |
| | | Enzymatic | shock, dialysis | heat treatment, | 30 wt. % | Upper Level of |
| | Untreated | hydrolysis | or washing | Trevelyan | Soybean | RNA per day, |
| | SBY | Marson 2020^{a} | Canepa 1972^{b} | 1976^{c} | meal | g (FDA 2022)l |
| RNA level, % wt. | 10.00-15.00 | | | | | |
| RNA level for 50 g protein (according | | 3.33-5.00 | 1.67-2.00 | 0.57-2.39 | 0.19 | <2 |
| to FDA RDA based on 2000 cal diet), g | | | | | | |
| RNA level for 60 g protein (average | | 4.00-6.00 | 2.00-2.40 | 0.68-2.87 | 0.22 | <2 |
| amount of protein consumed from red | | | | | | |
| meat, poultry, and fish (boneless | | | | | | |
| weight) in the US), g | | | | | | |
| Safe amount according to the FDA | | 20.00-30.03 | 50.00-59.88 | 41.84-175.44 | 537.69 | — |
| 2022 of protein for daily consumption | | | | | | |
| based on RNA content, g | | | | | | |
| Maximum amount of meat to eat safely | | 0.08-0.12 | 0.19-0.23 | 0.16-0.67 | 2.07 | — |
| per day (based on animal equivalent | | | | | | |
| containing 26 g protein per 100 g), kg | | | | | | |

^{a}Marson, G. V.; Saturno, R. P.; Comunian, T. A.; Consoli, L.; Machado, M. T. D. C.; Hubinger, M. D. Maillard conjugates from spent brewer's yeast by-product as an innovative encapsulating material. Food Res. Int. 2020, 136, 109365.
^{b}Canepa, A.; Pieber, M.; Romero, C.; Toha, J. C. A method for large reduction of the nucleic acid content of yeast. Biotechnol. Bioeng. 1972, 14, 173-177.
^{c}Trevelyan, W. E. Chemical methods for the reduction of the purine content of baker's yeast, a form of single-cell protein. J. Sci. Food Agric. 1976, 27, 225-230.

### EXAMPLES

The present disclosure will be more fully understood by reference to the following examples. It is understood that the present disclosure is not necessarily limited to the examples described in this section.

### Example 1—Liquid SBY and Soybean Meal

70% by weight of liquid SBY containing 20% solids and 10-15% by dry weight of RNA was mixed with 30% by weight Soybean meal containing 50% by dry weight protein and subjected to high moisture extrusion at a temperature of 150 degrees Celsius, a pressure of 20 bar, a rotation of RPM 400, and a time period of 2 minutes.

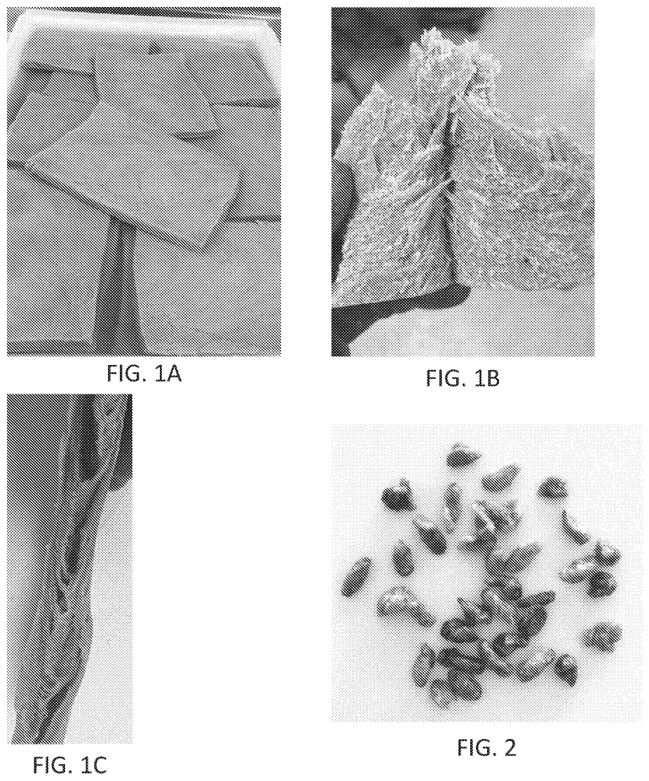

The resulting product had 57.8% moisture, 23.3% dry weight of protein, and 0.089% RNA by dry weight of the product. The protein content was measured according to AACC 46-30 and AOAC 992.15. RNA extraction was performed, RNA quantification was measured via spectrophotometer and the residual RNA percentage was calculated based on the RNA concentration. The product had a meaty flavor and a muscle-like fibrous texture as shown in FIG. 1.

### Example 2—Liquid SBY and Yellow Pea

40% by weight of liquid SBY containing 20% solids and 10-15% by dry weight of RNA was mixed with 60% by weight Yellow pea containing 24% by dry weight of protein and subjected to extrusion at a temperature of 130 degrees Celsius, pressure 10 bar, RPM 400 for 1 minute.

The resulting product had 36.2% moisture, 18.4% dry weight of protein and 0.094% RNA by dry weight of the product. The protein content was measured according to AACC 46-30 and AOAC 992.15. RNA extraction was performed, RNA quantification was measured via spectrophotometer and the residual RNA percentage was calculated based on the RNA concentration. The resulting product had a meaty flavor and fibrous texture similar to vegetable bacon bits in FIG. 2.

### Example 3—Chicken Skewers, 22.2% by Weight Dry Equivalent of SBY

65% by weight liquid SBY, containing 11% solids, 49.6% by dry weight of protein, and 15% by weight dried, solid SBY, containing 51.2% by dry weight protein and 10-15% by dry weight of RNA was mixed with 20% by weight Soybean meal containing 50.4% by dry weight protein and subjected to high moisture extrusion at a temperature of 150 degrees Celsius, a pressure of 20 bar, a rotation of 400 RPM, and for a time period of 2 minutes.

Chicken-like skewers were prepared according to the following instructions: 0.5 kg of SBY-based food product cut into 25 mm square pieces and they were marinated 2-6 hrs in a refrigerator (marinade: 2 tablespoons Miso paste, ¼ cup Lime juice, 1 teaspoon vegan fish sauce, 1 teaspoon shoyu, 2 teaspoons honey, 1 Jalapeño thin-sliced, 1 tablespoon toasted sesame oil). Vegetables and the SBY-based food product were put on skewers. The vegetables were Crimini or shiitake mushrooms, sweet onion, Sweet pepper. The skewers were then grilled on each side for 30 seconds.

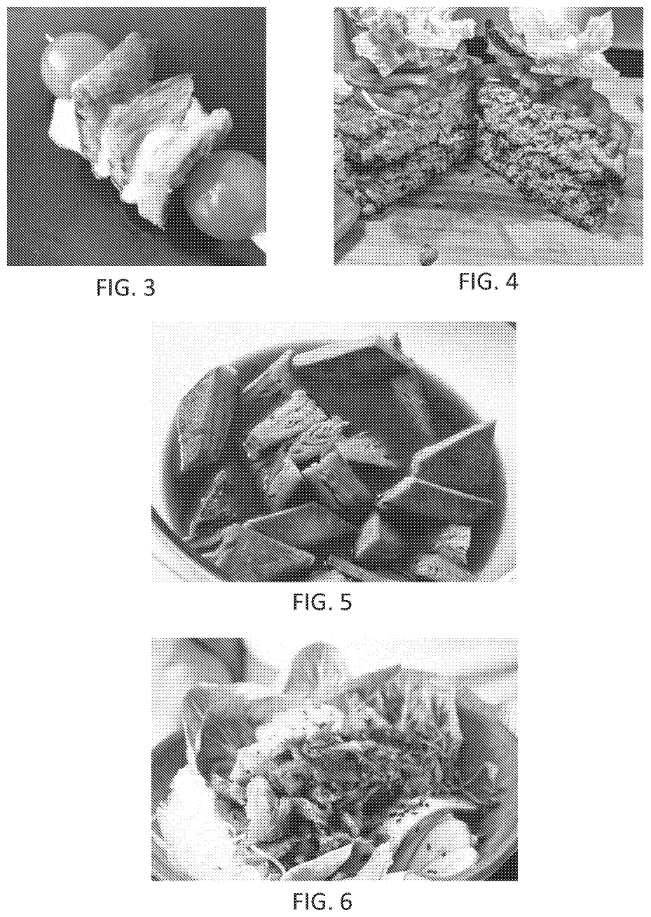

The resulting product had a clean chicken-like taste with miso lime flavor and a muscle-like fibrous texture as shown in FIG. 3. The resulting product had 22.2% by weight dry equivalent of SBY, 59.5% moisture content, 21.3% by dry weight of protein, and 0.072% RNA. The protein content was measured according to AACC 46-30 and AOAC 992.15. RNA extraction was performed, RNA quantification was measured via spectrophotometer and the residual RNA percentage was calculated based on the RNA concentration.

### Example 4—Hop-Char Burger, 27.5% by Weight Dry Equivalent of SBY

70% by weight liquid concentrated SBY, containing 25% solids, 49.6% by dry weight of protein, and 10% by weight dried, solid SBY, containing 51.2% by dry weight of protein and 10-15% by dry weight of RNA was mixed with 20% by weight Soybean meal containing 50.4% protein and subjected to high moisture extrusion at a temperature 150 degrees Celsius, a pressure of 20 bar, a rotation of 400 RPM, and for a time period of 2 minutes.

Hop-char burger was prepared according to the following instructions: 1 lb SBY-based meat, 6 oz cooked shiitake mushrooms, 1 tablespoon smoked paprika, 1 tablespoon honey, 1 tablespoon dark soy sauce, Irish moss equivalent of 2 small eggs, and Salt & Pepper about 0.05% total weight were combined in a food processor till broken down but not fully blended. Mushrooms, spices, honey, soy sauce, and herbs were added and blended till ground beef consistency was obtained. Then it was transferred to a bowl to mix with the egg substitute till moisture content was matched to fresh ground beef. Then, patties formed 35 mm thick and cooked on a charbroiler.

The resulting product had a succulent mouthfeel, umami flavor, and texture of ground beef as shown in FIG. 4. The resulting product had 27.5% by weight dry equivalent of SBY, 57.6% Moisture content, 23.9% protein, and 0.089% RNA. The protein content was measured according to AACC 46-30 and AOAC 992.15. RNA extraction was performed, RNA quantification was measured via spectrophotometer and the residual RNA percentage was calculated based on the RNA concentration.

### Example 5—Beef Stew, 30% by Weight Dry Equivalent of SBY

30% by weight dried, solid SBY, containing 51.2% protein and 10-15% by dry weight of RNA was mixed with 10% by weight Soy protein isolate, containing 90% by dry weight protein, and water resulting in a 60% by weight moisture mixture. The mixture was subjected to high moisture extrusion at a temperature of 150 degrees Celsius, a pressure of 20 bar, a rotation of 400 RPM, and for a time period of 2 minutes.

Beef stew was prepared according to the following instructions: 1 lb SBY-based meat cut into approximate 25 mm triangles, 8 oz yellow onion, large dice, 8 oz carrot, 1″ dice or oblique cut, 6 oz russet potatoes, peeled, large dice, ½ cup tamari (or soy sauce), 3½ cups room temperature water, 3 tablespoons raw sugar, 2 tablespoons curry powder, 3-3.5 oz prepared curry roux, 3 tablespoons neutral oil (grapeseed, avocado, canola). To make the marinade, the following were combined: tamari, sugar, curry powder, and 1 cup of water and whisked together until the sugar was dissolved. The SBY-based meat was seared in a medium saucepan with 2 tablespoons of the oil for approximately 2 minutes per side. Once it was browned, the food product was plunged into the marinade and let stand for 10 minutes at room temperature. Using the same pan, the remaining oil was added and the carrots and onion were sautéed over medium heat for about 3 minutes while stirring frequently. The potatoes were added and stirred. Then a curry roux was crumbled in and stirred until it appears to be evenly distributed, which took about 30 seconds. The remaining water (2½ cups) was added, stirred, and the whole mixture was brought to a boil. Once boiling, the heat was reduced to low, covered and simmered for about 15 minutes while stirring frequently. The potatoes and carrots were slightly tender when poked with a knife at this point indicating that it's done. It was served with steamed rice.

The resulting product had a strong beefy umami flavor and a muscle-like fibrous texture as shown in FIG. 5. The resulting product had 30% by weight dry equivalent of SBY, 60% Moisture content, 24.4% by dry weight of protein, and 0.099% RNA. The protein content was measured according to AACC 46-30 and AOAC 992.15. RNA extraction was performed, RNA quantification was measured via spectrophotometer and the residual RNA percentage was calculated based on the RNA concentration.

### Example 6—Pulled Pork, 40% by Weight Dry Equivalent of SBY

40% by weight dried, solid SBY, containing 51.2% protein and 10-15% by dry weight of RNA was mixed with 10% by weight Soy protein isolate, containing 90% protein, and water resulting in a 50% by weight moisture mixture. The mixture was then subjected to high moisture extrusion at a temperature 150 degrees Celsius, a pressure of 20 bar, a rotation of 400 RPM, and for a time period of 2 minutes.

Pulled pork lemongrass veggie bowl was prepared according to the following instructions: The following ingredients were used to make 1 large bowl: 4 oz. SBY-based meat, shredded, 1 cup Rice noodles, cooked, ⅓ cup Purple Cabbage, sliced, ½ Mango, sliced, 5 each Snap Peas, 4 leaves head Little Gems Lettuce, 5 thin slices Watermelon Radish, Sprinkle of Black Sesame & Lime wedges. The marinade & dressing to make 2 cups was prepared with the following ingredients: ½ cup Lime Juice & Lime zest, 2 Tablespoons Soy Sauce, ⅓ cup Fish Sauce, ¼ cup Maple Syrup, ¼ Oil, 4-8 gloves Garlic, 2-3 stalks Lemon Grass, tender white parts only, chopped, 1 shallot, peeled & halved. To make marinade & dressing: the ingredients were combined in a blender and seasoned with Salt & pepper. The marinade was divided in half and ¼ cup of marinade was used to marinate shredded SBY-based food product in a small bowl for 5 minutes. To assemble the bowl: a cast iron pan was heated until very hot. The SBY-based food product was seared until caramelized and crispy. More marinade was added as needed. In a large serving bowl, all the remaining fresh bowl ingredients were arranged. The seared SBY-based food product was placed on top. A few tablespoons of the remaining marinade was drizzled on top.

The resulting product had a pronounced meaty flavor and muscle-like fibers as shown in FIG. 6. The resulting product had 40% by weight dry equivalent of SBY, 50% moisture content, 29.5% protein, and 1.32% RNA. The protein content was measured according to AACC 46-30 and AOAC 992.15. RNA extraction was performed, RNA quantification was measured via spectrophotometer and the residual RNA percentage was calculated based on the RNA concentration.

One skilled in the art will recognize that the herein described methods, processes, systems, apparatus, components, devices, operations/actions, and objects, and the discussion accompanying them, are used as examples for the sake of conceptual clarity and that various configuration modifications are contemplated. Consequently, as used herein, the specific examples/embodiments set forth and the accompanying discussions are intended to be representative of their more general classes. In general, use of any specific exemplar is intended to be representative of its class, and the non-inclusion of specific components, devices, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed, and not as more narrowly defined by particular illustrative aspects provided herein.
Clause 1. A method for processing liquid spent brewers' yeast as the primary ingredient and at least one secondary protein ingredient into food product suitable for safe human consumption, the method comprising:
   subjecting a mix of primary and secondary ingredients to heat treatment at a temperature higher than 90° C. at an elevated pressure of at least 8 bar for at least 1 minute.
Clause 2. The method of clause 1, wherein the heat and pressure treatment is applied by extrusion.
Clause 3. The method of any one of clauses 1-2, wherein the temperature may vary from 90 C to 180 C, preferably 150 C.
Clause 4. The method of any one of clauses 1-3, wherein the pressure may vary from 8 to 150 bar, preferably 20 bar.
Clause 5. The method of any one of clauses 1-4, wherein the processing time may vary from 1 to 5 minutes, preferably 2 minutes.
Clause 6. The method of any one of clauses 1-5, wherein the primary ingredient is chosen from spent distillers' yeast, liquid bakers' yeast, liquid nutritional yeast, or surplus yeast from ethanol manufacturing.
Clause 7. The method of any one of clauses 1-6, wherein the primary ingredient is derived from various strains of Saccharomycetes class, such as Saccharomyces cerevisiae, Saccharomyces pastorianus, Saccharomyces carlsbergensis, etc.
Clause 8. The method of any one of clauses 1-7, wherein the primary ingredient is obtained by mixing dry spent brewers yeast and liquid.
Clause 9. The method of any one of clauses 1-8, wherein the primary ingredient can be debittered, autolyzed, or hydrolyzed.
Clause 10. The method of any one of clauses 1-9, wherein the secondary protein ingredient is chosen from vegetable protein, microbial protein, fungal protein, animal protein, cultured protein in their native, concentrated, or isolated form, or a combination thereof.
Clause 11. The method of any one of clauses 1-10, wherein the secondary protein ingredient may contain fat, carbohydrate, flavoring agent, colorant, Calcium Chloride, gums, lecithin, or a combination thereof.
Clause 12. The method of any one of clauses 1-11, wherein the ratio of the liquid spent brewers yeast is about 80% and secondary protein ingredients are about 20%.
Clause 13. The method of any one of clauses 1-11, wherein the ratio of the liquid spent brewers yeast is about 70% and secondary protein ingredients are about 30%.
Clause 14. The method of any one of clauses 1-11, wherein the ratio of the liquid spent brewers yeast is about 60% and secondary protein ingredients are about 40%.
Clause 15. The method of any one of clauses 1-11, wherein the ratio of the liquid spent brewers yeast is about 50% and secondary protein ingredients are about 50%.
Clause 16. The method of any one of clauses 1-11, wherein the ratio of the liquid spent brewers yeast is about 40% and secondary protein ingredients are about 60%.
Clause 17. The method of any one of clauses 1-11, wherein the ratio of the liquid spent brewers yeast is about 30% and secondary protein ingredients are about 70%.
Clause 18. The method of any one of clauses 1-11, wherein the ratio of the liquid spent brewers yeast is about 20% and secondary protein ingredients are about 80%.
Clause 19. The method of any one of clauses 1-18, wherein the RNA content in the food product is less than 4% of the food product's protein dry weight.
Clause 20. The method of any one of claims 1-19, wherein the RNA content in the food product is less than 2 g per serving.
Clause 21. A food product, comprising:
   20%-80% by weight of spent brewers' yeast,
   at least one secondary protein ingredient,
   0.001-2.000 g of RNA.
Clause 22. The product of clause 21, wherein the spent brewer's yeast source is chosen from spent brewers' yeast, spent distillers' yeast, surplus yeast from ethanol manufacturing, bakers' yeast, nutritional yeast, or a combination thereof.
Clause 23. The product of any one of clauses 21-22, wherein the spent brewer's yeast source is derived from various strains of Saccharomycetes class, such as Saccharomyces cerevisiae, Saccharomyces pastorianus, Saccharomyces carlsbergensis, etc.
Clause 24. The product of any one of clauses 21-23, wherein the spent brewer's yeast is used in the dry, concentrated, liquid form, or a combination thereof.
Clause 25. The product of any one of clause 21-24, wherein the spent brewer's yeast contains from about 10% to about 100% solids.
Clause 26. The product of any one of clauses 21-25, wherein the spent brewer's yeast source is debittered, autolyzed, or hydrolyzed.
Clause 27. The product of any one of clauses 21-26, wherein the secondary protein ingredient is chosen from vegetable protein, microbial protein, fungal protein, animal protein, cultured protein in their native, concentrated, or isolated form, or a combination thereof.
Clause 28. The product of any one of clauses 21-27, wherein the secondary protein ingredient may contain fat, carbohydrate, flavoring agent, colorant, minerals, vitamins, gums, lecithin, or a combination thereof.
Clause 29. The product of any one of clauses 21-28, wherein the ratio of the spent brewer's yeast is about 80% and secondary protein ingredients are about 20%.
Clause 30. The product of any one of clauses 21-28, wherein the ratio of the spent brewer's yeast is about 70% and secondary protein ingredients are about 30%.
Clause 31. The product of any one of clauses 21-28, wherein the ratio of the spent brewer's yeast is about 60% and secondary protein ingredients are about 40%.
Clause 32. The product of any one of clauses 21-28, wherein the ratio of the spent brewer's yeast is about 50% and secondary protein ingredients are about 50%.
Clause 33. The product of any one of clauses 21-28, wherein the ratio of the spent brewer's yeast is about 40% and secondary protein ingredients are about 60%.
Clause 34. The product of any one of clauses 21-28, wherein the ratio of the spent brewer's yeast is about 30% and secondary protein ingredients are about 70%.
Clause 35. The product of any one of clauses 21-28, wherein the ratio of the spent brewer's yeast is about 20% and secondary protein ingredients are about 80%.
Clause 36. The product of any one of clauses 21-35, wherein the RNA content in the food product is less than 4% of the food product's protein dry weight.
Clause 37. The product of any one of clauses 21-36, wherein the RNA content in the food product is less than 2 g per serving.
Clause 38. The product of any one of clauses 21-37, wherein the food product is a textured vegetable protein, alternative meat, an application thereof, or a combination thereof.
Clause 39. A method of processing liquid yeast into a food product, the method comprising:
thermo-mechanically processing a mixture comprising a liquid yeast and a secondary protein ingredient utilizing a temperature of at least 90 degrees Celsius and at an elevated pressure of at least 8 bar to form the food product,
wherein the mixture comprises a range of 40% to 80% of the liquid yeast based on the total weight of the mixture and a ribonucleic acid content in the food product is less than 4% of the dry protein weight of the food product.
Clause 40. The method of clause 39 wherein the temperature is in a range of 90 degrees Celsius to 180 degrees Celsius, the elevated pressure is in a range of 8 bar to 150 bar, and the temperature and elevated pressure are applied together for a time in a range of 1 minute to 5 minutes.
Clause 41. The method of any one of clauses 39-40 wherein the mixture comprises a range of 40% to 80% by weight of liquid yeast based upon the total weight of the mixture, such as, 60% to 80% by weight, 65% to 70% by weight, 40% to 70% by weight, or 40% to 60% by weight, all based upon the total weight of the mixture.
Clause 42. The method of any one of clauses 39-41 wherein the mixture comprises a range of 20% to 60% by weight of the secondary protein ingredient based upon the total weight of the mixture, such as, 20% to 40% by weight, 20% to 50% by weight, or 40% to 60% by weight, all based upon the total weight of the mixture.
Clause 43. The method of any one of clauses 39-42 wherein the liquid yeast comprises spent brewers' yeast, spent distillers' yeast, bakers' yeast, nutritional yeast, surplus yeast from ethanol manufacturing, or a combination thereof, such as, the liquid yeast comprises spent brewers' yeast.
Clause 44. The method of any one of clauses 39-43 wherein the liquid yeast is obtained by mixing dry yeast with a liquid.
Clause 45. The method of any one of clauses 39-44 wherein the secondary protein ingredient comprises a vegetable protein, a microbial protein, a fungal protein, an animal protein, a cultured protein, or a combination thereof, and wherein the secondary protein is in a native form, a concentrated form, an isolated form, or a combination thereof.
Clause 46. The method of any one of clauses 39-45, wherein the thermo-mechanically processing comprises an extrusion process, a shear cell process, or a combination thereof, such as, the thermo-mechanically processing comprises an extrusion process.
Clause 47. A food product formed by the method of any of clauses 39-46.
Clause 48. A food product comprising:
at least 20% of a yeast by weight based on the dry weight of the food product; and
a ribonucleic acid (RNA) content less than 4% by weight based on the dry weight of the food product, such as, no greater than 3% by weight, no greater than 2% by weight, no greater than % 1 by weight, no greater than 0.5%, or no greater than 0.14% by weight, all based on the dry weight of the food product.
Clause 49. The food product of clause 48 wherein the liquid yeast comprises spent brewers' yeast, spent distillers' yeast, bakers' yeast, nutritional yeast, surplus yeast from ethanol manufacturing, or a combination thereof, such as, the liquid yeast comprises spent brewers' yeast.
Clause 50. The food product of any one of clauses 48-49, further comprising at least 20% by weight of a secondary protein ingredient based on the total weight of the food product, wherein the secondary protein ingredient comprises a vegetable protein, a microbial protein, a fungal protein, an animal protein, a cultured protein, or a combination thereof, wherein the secondary protein is in a native form, a concentrated form, an isolated form, or a combination thereof.
Clause 51. The meat substitute of clause 50 wherein the food product is produced by thermo-mechanically processing a mixture comprising liquid yeast and the second protein ingredient.
Clause 52. The food product of clause 51, wherein the liquid yeast comprises a range of 8% to 25% by weight of solids based on the total weight of the liquid yeast, such as, 8% to 11% by weight or 15% to 25% by weight, all based on the total weight of the liquid yeast.
Clause 53. The method of any one of clauses 51-52, wherein the thermo-mechanically processing comprises an extrusion process, a shear cell process, or a combination thereof, such as, the thermo-mechanically processing comprises an extrusion process.
Clause 54. The food product of any one of clauses 51-53, wherein the mixture comprises a range of 40% to 80% by weight of liquid yeast based upon the total weight of the mixture, such as, for example, 60% to 80% by weight, 65% to 70% by weight, 40% to 70% by weight, or 40% to 60% by weight, all based upon the total weight of the mixture.
Clause 55. The food product of any one of clauses 48-54, wherein the food product comprises a range of 10% to 20% by weight of protein from the yeast based on the total dry weight of the food product.

Any patent, publication, or other disclosure material identified herein is incorporated herein by reference in its entirety unless otherwise indicated but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout the specification to “various examples,” “some examples,” “one example,” or “an example”, or the like, means that a particular feature, structure, or characteristic described in connection with the example is included in at least one example. Thus, appearances of the phrases “in various examples,” “in some examples,” “in one example”, or “in an example”, or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features structures, or characteristics of one or more other examples without limitation. Such modifications and variations are intended to be included within the scope of the present examples.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

All ranges recited herein are inclusive of the end points of the recited ranges. For example, a range of “1 to 10” includes the end points 1 and 10. Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

In this specification, unless otherwise indicated, all percentages (e.g., weight percent protein, percent protein, percent moisture) are to be understood as being based on weight.

One skilled in the art will recognize that the herein described methods, processes, systems, apparatus, components, devices, operations/actions, and objects, and the discussion accompanying them, are used as examples for the sake of conceptual clarity and that various configuration modifications are contemplated. Consequently, as used herein, the specific examples/embodiments set forth and the accompanying discussions are intended to be representative of their more general classes. In general, use of any specific exemplar is intended to be representative of its class, and the non-inclusion of specific components, devices, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed, and not as more narrowly defined by particular illustrative aspects provided herein.

### REFERENCES

1. Dietary Guidelines for Americans, Ninth edition, 2020
https://www.dietaryguidelines.gov
2. USDA Food Availability (Per Capita) Data System, 2021
https://www.ers.usda.gov/data-products/food-availability-per-capita-data-system/
3. J. C. Edozien et al. Effects of high levels of yeast feeding on uric acid metabolism of young men. Nature vol 228, 1970
4. Marson, G. V.; Saturno, R. P.; Comunian, T. A.; Consoli, L.; Machado, M. T. D. C.; Hubinger, M. D. Maillard conjugates from spent brewer's yeast by-product as an innovative encapsulating material. Food Res. Int. 2020, 136, 109365.
5. Canepa, A.; Pieber, M.; Romero, C.; Tohá, J. C. A method for large reduction of the nucleic acid content of yeast. Biotechnol. Bioeng. 1972, 14, 173-177.
6. Trevelyan, W. E. Chemical methods for the reduction of the purine content of baker's yeast, a form of single-cell protein. J. Sci. Food Agric. 1976, 27, 225-230.
7. Steven H. V. Cornet, Silvia J. E. Snel, Floor K. G. Schreuders, Ruud G. M. van der Sman, Michael Beyrer & Atze Jan van der Goot (2021): Thermo-mechanical processing of plant proteins using shear cell and high-moisture extrusion cooking, Critical Reviews in Food Science and Nutrition, DOI: 10.1080/10408398.2020.1864618

1. A method of processing liquid yeast into a food product, the method comprising:
thermo-mechanically processing a mixture comprising a liquid yeast and a secondary protein ingredient utilizing a temperature of at least 90 degrees Celsius and at an elevated pressure of at least 8 bar to form the food product,
wherein the mixture comprises a range of 40% to 80% of the liquid yeast based on the total weight of the mixture and a ribonucleic acid content in the food product is less than 4% of the dry protein weight of the food product.

2. The method of claim 1 wherein the temperature is in a range of 90 degrees Celsius to 180 degrees Celsius, the elevated pressure is in a range of 8 bar to 150 bar, and the temperature and elevated pressure are applied together for a time in a range of 1 minute to 5 minutes.

3. The method of claim 1 wherein the mixture comprises a range of 40% to 80% by weight of liquid yeast based upon the total weight of the mixture, such as, 60% to 80% by weight, 65% to 70% by weight, 40% to 70% by weight, or 40% to 60% by weight, all based upon the total weight of the mixture.

4. The method of claim 1 wherein the mixture comprises a range of 20% to 60% by weight of the secondary protein ingredient based upon the total weight of the mixture, such as, 20% to 40% by weight, 20% to 50% by weight, or 40% to 60% by weight, all based upon the total weight of the mixture.

5. The method of claim 1 wherein the liquid yeast comprises spent brewers' yeast, spent distillers' yeast, bakers' yeast, nutritional yeast, surplus yeast from ethanol manufacturing, or a combination thereof, such as, the liquid yeast comprises spent brewers' yeast.

6. The method of claim 1 wherein the liquid yeast is obtained by mixing dry yeast with a liquid.

7. The method of claim 1 wherein the secondary protein ingredient comprises a vegetable protein, a microbial protein, a fungal protein, an animal protein, a cultured protein, or a combination thereof, and wherein the secondary protein is in a native form, a concentrated form, an isolated form, or a combination thereof.

8. The method of claim 1, wherein the thermo-mechanically processing comprises an extrusion process, a shear cell process, or a combination thereof, such as, the thermo-mechanically processing comprises an extrusion process.

9. A food product formed by the method of claim 1.

10. A food product comprising:
at least 20% of a yeast by weight based on the dry weight of the food product; and
a ribonucleic acid (RNA) content less than 4% by weight based on the dry weight of the food product, such as, no greater than 3% by weight, no greater than 2% by weight, no greater than % 1 by weight, no greater than 0.5%, or no greater than 0.14% by weight, all based on the dry weight of the food product.

11. The food product of claim 10 wherein the liquid yeast comprises spent brewers' yeast, spent distillers' yeast, bakers' yeast, nutritional yeast, surplus yeast from ethanol manufacturing, or a combination thereof, such as, the liquid yeast comprises spent brewers' yeast.

12. The food product of claim 10, further comprising at least 20% by weight of a secondary protein ingredient based on the total weight of the food product, wherein the secondary protein ingredient comprises a vegetable protein, a microbial protein, a fungal protein, an animal protein, a cultured protein, or a combination thereof, wherein the secondary protein is in a native form, a concentrated form, an isolated form, or a combination thereof.

13. The food product of claim 10 wherein the food product is produced by thermo-mechanically processing a mixture comprising liquid yeast and the second protein ingredient.

14. The food product of claim 13, wherein the liquid yeast comprises a range of 8% to 25% by weight of solids based on the total weight of the liquid yeast, such as, 8% to 11% by weight or 15% to 25% by weight, all based on the total weight of the liquid yeast.

15. The food product of claim 13, wherein the thermo-mechanically processing comprises an extrusion process, a shear cell process, or a combination thereof, such as, the thermo-mechanically processing comprises an extrusion process.

16. The food product of claim 13, wherein the mixture comprises a range of 40% to 80% by weight of liquid yeast based upon the total weight of the mixture, such as, for example, 60% to 80% by weight, 65% to 70% by weight, 40% to 70% by weight, or 40% to 60% by weight, all based upon the total weight of the mixture.

17. The food product of claim 10, wherein the food product comprises a range of 3% to 20% by weight of protein from the yeast based on the total dry weight of the food product.

18. The food product of claim 10, wherein the food product comprises a textured vegetable protein, an alternative meat, an application thereof, or a combination thereof.
